(19) United States
(12) Patent Application Publication
(10) Pub. No.: US 2023/0224864 A1
(43) Pub. Date: Jul. 13, 2023

(54) ENABLING MINI-SLOT DETECTION IN SIDELINK

(71) Applicant: QUALCOMM Incorporated, San Diego, CA (US)

(72) Inventors: Jung Ho RYU, Fort Lee, NJ (US); Junyi LI, Fairless Hills, PA (US); Tao LUO, San Diego, CA (US); Sony AKKARAKARAN, Poway, CA (US); Juan MONTOJO, San Diego, CA (US); Wooseok NAM, San Diego, CA (US); Yan ZHOU, San Diego, CA (US); Peter GAAL, San Diego, CA (US); Xiaojie WANG, Hillsborough, NJ (US); Hua WANG, Basking Ridge, NJ (US); Piyush GUPTA, Bridgewater, NJ (US); Xiaoxia ZHANG, San Diego, CA (US); Lik Hang Silas FONG, Bridgewater, NJ (US); Chih-Hao LIU, San Diego, CA (US); Jing SUN, San Diego, CA (US)

(21) Appl. No.: 17/647,721

(22) Filed: Jan. 11, 2022

(51) Int. Cl. H04W 72/02; H04W 72/04

(52) U.S. Cl. CPC H04W 72/02; H04W 72/0446; H04W 72/0406

(57) ABSTRACT

Certain aspects of the present disclosure provide techniques for enabling mini-slot detection in sidelink. A method performed by a user equipment (UE) includes receiving a sidelink configuration comprising a set of configuration parameters. The set of configuration parameters defines a plurality of sidelink mini-slots within a slot structure. The method may further include performing communications in one or more of the plurality of sidelink mini-slots.

### INTRODUCTION

Aspects of the present disclosure relate to wireless communications, and more particularly, to techniques for enabling mini-slot detection in sidelink communications.

Wireless communication systems are widely deployed to provide various telecommunication services such as telephony, video, data, messaging, broadcasts, or other similar types of services. These wireless communication systems may employ multiple-access technologies capable of supporting communication with multiple users by sharing available system resources with those users (e.g., bandwidth, transmit power, or other resources). Multiple-access technologies can rely on any of code division, time division, frequency division orthogonal frequency division, single-carrier frequency division, or time division synchronous code division, to name a few. These and other multiple access technologies have been adopted in various telecommunication standards to provide a common protocol that enables different wireless devices to communicate on a municipal, national, regional, and even global level.

Although wireless communication systems have made great technological advancements over many years, challenges still exist. For example, complex and dynamic environments can still attenuate or block signals between wireless transmitters and wireless receivers, undermining various established wireless channel measuring and reporting mechanisms, which are used to manage and optimize the use of finite wireless channel resources. Consequently, there exists a need for further improvements in wireless communications systems to overcome various challenges.

### SUMMARY

In one aspect, a method for wireless communications by a user equipment includes receiving a sidelink configuration comprising a set of configuration parameters, wherein the set of configuration parameters defines a plurality of sidelink mini-slots within a slot structure; and performing communications in one or more of the plurality of sidelink mini-slots.

Other aspects provide: an apparatus operable, configured, or otherwise adapted to perform the aforementioned methods as well as those described elsewhere herein; a non-transitory, computer-readable media comprising instructions that, when executed by one or more processors of an apparatus, cause the apparatus to perform the aforementioned methods as well as those described elsewhere herein; a computer program product embodied on a computer-readable storage medium comprising code for performing the aforementioned methods as well as those described elsewhere herein; and an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF THE DRAWINGS

The appended figures depict certain features of the various aspects described herein and are not to be considered limiting of the scope of this disclosure.

FIG. 1 is a block diagram conceptually illustrating an example wireless communication network.

FIG. 2 is a block diagram conceptually illustrating aspects of an example a base station and user equipment.

FIGS. 3A-3D depict various example aspects of data structures for a wireless communication network.

FIG. 4 depicts an example of current sidelink slot structures according to aspects of the present disclosure.

FIG. 5 depicts an example of sidelink mini-slot structures within a conventional slot structure, according to aspects of the present disclosure.

FIG. 6 depicts further examples of mini-slot structures, including related sidelink configuration parameters, according to aspects of the present disclosure.

FIG. 7 depicts example sidelink resource pool information elements, each configured with sidelink configuration examples for different resource pools.

FIG. 8 depicts an example of a process for wireless communication according to aspects of the present disclosure.

FIG. 9 depicts another example of a process for wireless communication according to aspects of the present disclosure.

FIG. 10 depicts an example of a communications device according to aspects of the present disclosure.

FIG. 11 depicts an example of another communications device according to aspects of the present disclosure.

### DETAILED DESCRIPTION

Aspects of the present disclosure provide apparatuses, methods, processing systems, and computer-readable mediums for enabling mini-slots in sidelink communications.

Sidelink communications generally refer to direct communications between devices, such as user equipments. Sidelink communications beneficially allow for communication between such devices without traversing network resources (e.g., base stations), though a network may nevertheless be involved with configuring the sidelink resources so that simultaneous network and sidelink communications coexist.

Generally, sidelink communications structures mimic those of communications with the network, such as using slot-based allocation of time and frequency resources to determine when a device can transmit and/or receive data. Conventionally, slots comprise a fixed number of symbols, such as 14 orthogonal frequency-division multiplexing (OFDM) symbols in one example.

However, there are many occasions when transmitting and/or receiving data from a device requires fewer resources (e.g., symbols) than are allocated within a slot. Accordingly, it would be beneficial to further subdivide slots into “mini-slots”, for example, comprising two, four, seven, or some other number of OFDM symbols. Mini-slots may beneficially reduce latency and allow for efficient transmission of small amounts of data, which increases resource utilization.

Because mini-slots are not presently defined in any communication standard for sidelink communications, there exists the technical problem of how to signal characteristics of mini-slots between devices so that their benefits may be exploited while still working within existing slot-based frameworks of various wireless communication standards.

Aspects described herein provide a technical solution to the aforementioned technical problem by defining mechanisms for configuring mini-slots for sidelink communications. As described in more detail below, some aspects relate to defining mini-slot structures within sidelink bandwidth parts so that devices may use the mini-slot structures for communicating (e.g., transmitting and/or receiving) data. In some aspects, specific resource pools may be used to configure specific devices to use specific mini-slots.

Beneficially, aspects described herein enable sidelink communications to leverage mini-slot structures, which in-turn reduces latency and increases resource utilization in sidelink communications.

### Introduction to Wireless Communication Networks

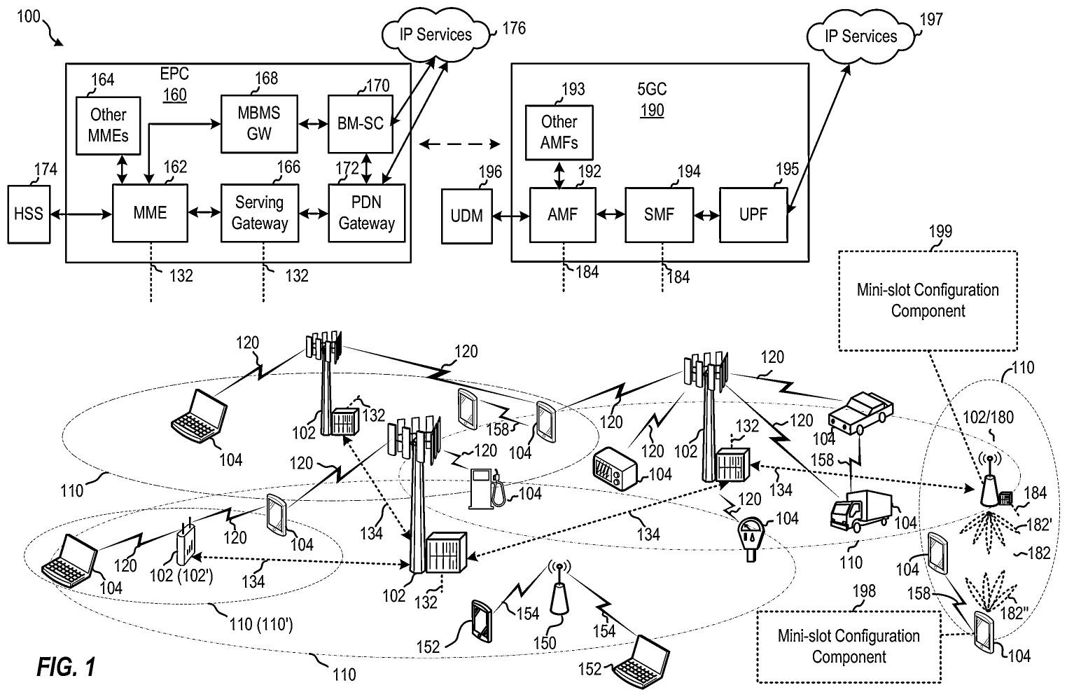

FIG. 1 depicts an example of a wireless communications system 100, in which aspects described herein may be implemented.

Generally, wireless communications system 100 includes base stations (BSs) 102, user equipments (UEs) 104, one or more core networks, such as an Evolved Packet Core (EPC) 160 and 5G Core (5GC) network 190, which interoperate to provide wireless communications services.

Base stations 102 may provide an access point to the EPC 160 and/or 5GC 190 for a user equipment 104, and may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, delivery of warning messages, among other functions. Base stations may include and/or be referred to as a gNB, NodeB, eNB, ng-eNB (e.g., an eNB that has been enhanced to provide connection to both EPC 160 and 5GC 190), an access point, a base transceiver station, a radio base station, a radio transceiver, or a transceiver function, or a transmission reception point in various contexts.

Base stations 102 wirelessly communicate with UEs 104 via communications links 120. Each of base stations 102 may provide communication coverage for a respective geographic coverage area 110, which may overlap in some cases. For example, small cell 102′ (e.g., a low-power base station) may have a coverage area 110′ that overlaps the coverage area 110 of one or more macrocells (e.g., high-power base stations).

The communication links 120 between base stations 102 and UEs 104 may include uplink (UL) (also referred to as reverse link) transmissions from a user equipment 104 to a base station 102 and/or downlink (DL) (also referred to as forward link) transmissions from a base station 102 to a user equipment 104. The communication links 120 may use multiple-input and multiple-output (MIMO) antenna technology, including spatial multiplexing, beamforming, and/or transmit diversity in various aspects.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player, a camera, a game console, a tablet, a smart device, a wearable device, a vehicle, an electric meter, a gas pump, a large or small kitchen appliance, a healthcare device, an implant, a sensor/actuator, a display, or other similar devices. Some of UEs 104 may be internet of things (IoT) devices (e.g., parking meter, gas pump, toaster, vehicles, heart monitor, or other IoT devices), always on (AON) devices, or edge processing devices. UEs 104 may also be referred to more generally as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, or a client.

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, base station 180 and the UE 104 may each include a plurality of antennas, such as antenna elements, antenna panels, and/or antenna arrays to facilitate the beamforming.

In some cases, base station 180 may transmit a beamformed signal to UE 104 in one or more transmit directions 182′. UE 104 may receive the beamformed signal from the base station 180 in one or more receive directions 182″. UE 104 may also transmit a beamformed signal to the base station 180 in one or more transmit directions 182″. Base station 180 may also receive the beamformed signal from UE 104 in one or more receive directions 182′. Base station 180 and UE 104 may then perform beam training to determine the best receive and transmit directions for each of base station 180 and UE 104. Notably, the transmit and receive directions for base station 180 may or may not be the same. Similarly, the transmit and receive directions for UE 104 may or may not be the same.

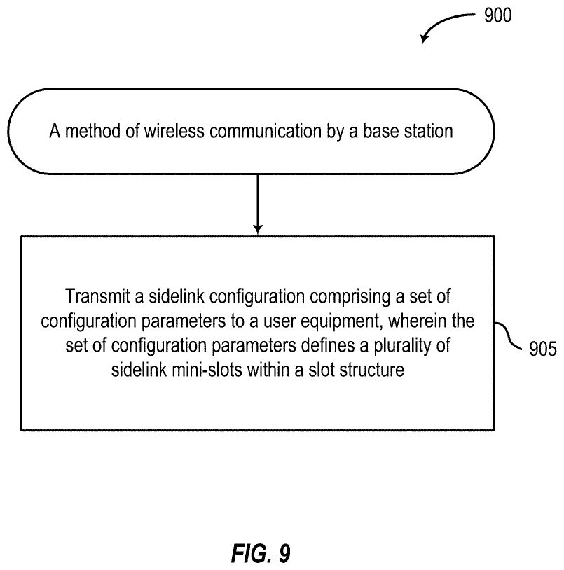

Wireless communication network 100 includes mini-slot configuration component 199, which may be configured to configure mini-slots for various network entities, including user equipments 104. Wireless network 100 further includes mini-slot configuration component 198, which may be used configured to perform operations for configuring mini-slots for sidelink communications, such as illustrated in FIG. 9.

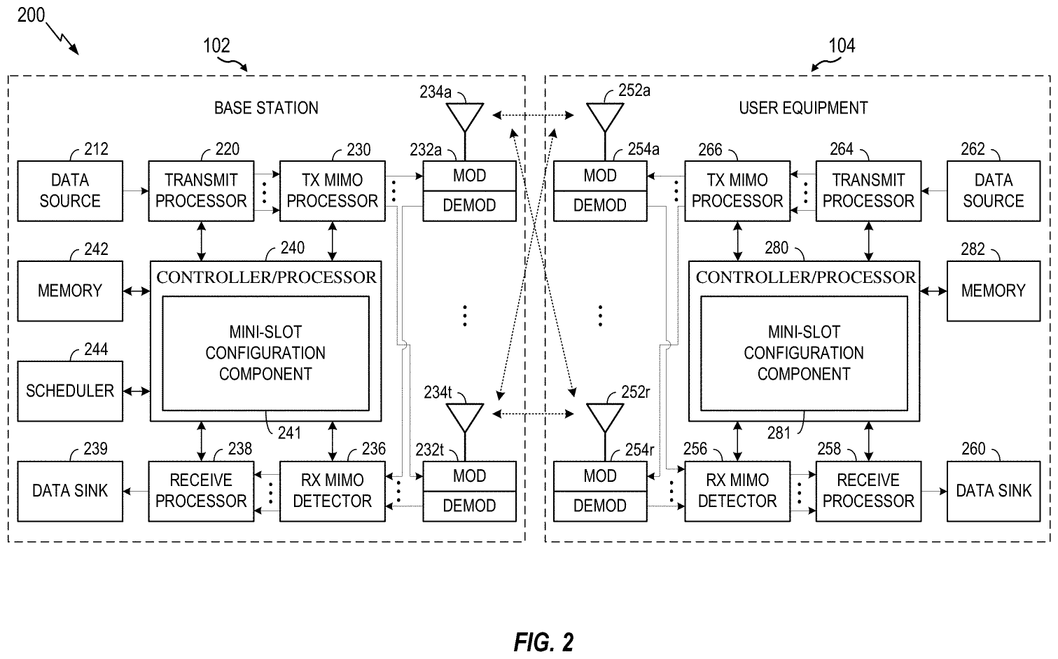

FIG. 2 depicts aspects of an example base station (BS) 102 and a user equipment (UE) 104.

Generally, base station 102 includes various processors (e.g., 220, 230, 238, and 240), antennas 234a-t (collectively 234), transceivers 232a-t (collectively 232), which include modulators and demodulators, and other aspects, which enable wireless transmission of data (e.g., data source 212) and wireless reception of data (e.g., data sink 239). For example, base station 102 may send and receive data between itself and user equipment 104.

Base station 102 includes controller/processor 240, which may be configured to implement various functions related to wireless communications. In the depicted example, controller/processor 240 includes mini-slot configuration component 241, which may be representative of mini-slot configuration component 199 of FIG. 1. Notably, while depicted as an aspect of controller/processor 240, mini-slot configuration component 241 may be implemented additionally or alternatively in various other aspects of base station 102 in other implementations.

Generally, user equipment 104 includes various processors (e.g., 258, 264, 266, and 280), antennas 252a-r (collectively 252), transceivers 254a-r (collectively 254), which include modulators and demodulators, and other aspects, which enable wireless transmission of data (e.g., data source 262) and wireless reception of data (e.g., data sink 260).

User equipment 104 includes controller/processor 280, which may be configured to implement various functions related to wireless communications. In the depicted example, controller/processor 280 includes mini-slot configuration component 281, which may be representative of mini-slot configuration component 198 of FIG. 1. Notably, while depicted as an aspect of controller/processor 280, mini-slot configuration component 281 may be implemented additionally or alternatively in various other aspects of user equipment 104 in other implementations.

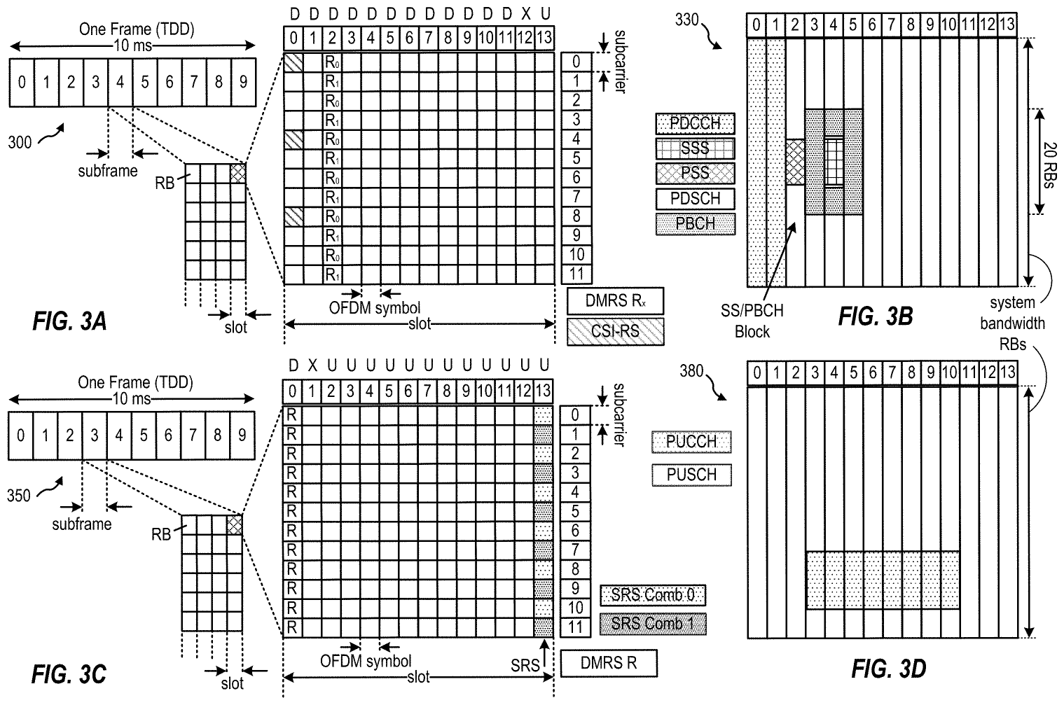

FIGS. 3A-3D depict aspects of data structures for a wireless communication network, such as wireless communication network 100 of FIG. 1. In particular, FIG. 3A is a diagram 300 illustrating an example of a first subframe within a 5G (e.g., 5G NR) frame structure, FIG. 3B is a diagram 330 illustrating an example of DL channels within a 5G subframe, FIG. 3C is a diagram 350 illustrating an example of a second subframe within a 5G frame structure, and FIG. 3D is a diagram 380 illustrating an example of UL channels within a 5G subframe.

Further discussions regarding FIG. 1, FIG. 2, and FIGS. 3A-3D are provided later in this disclosure.

### Introduction to Sidelink Slot Structure

As noted above, sidelink communications generally refer to direct communications between devices, such as user equipment to user equipment communications. Generally, sidelink communications may use communication structures, like slots, for these direct communications, which may comprise a fixed number of data symbols. For example, a typical slot may comprises 14 OFDM symbols, which may include, for example, downlink symbols, uplink symbols, flexible symbols, automatic gain control symbols, and other types. Generally, a slot is marked for sidelink communications if it contains OFDM symbols that can be used for sidelink communications.

Sidelink slots may have specific structure (or format) characteristics, such as always beginning with a symbol configured for automatic gain control (AGC). In such formats, symbols for physical sidelink shared channel (PSSCH) communications may begin in the second symbol of the slot and can be, for example, five to twelve symbols long. Further, a physical sidelink control channel (PSCCH) may be frequency duplexed with PSSCH in symbols, generally starting from second sidelink symbol in the slot, and is generally two or three symbols long. Remaining symbols in a sidelink slot are generally either gap symbols, physical sidelink feedback channel (PSFCH) symbols, downlink symbols, and/or uplink symbols, though other symbols are possible.

In some aspects, a sidelink slot structure may be configured using a sidelink configuration consisting of a set of parameters including a sidelink symbol start parameter and a sidelink symbol length parameter. The sidelink start parameter provides a symbol index corresponding to the first symbol that the sidelink slot will occupy. The sidelink symbol length parameter defines the length of the sidelink slot structure.

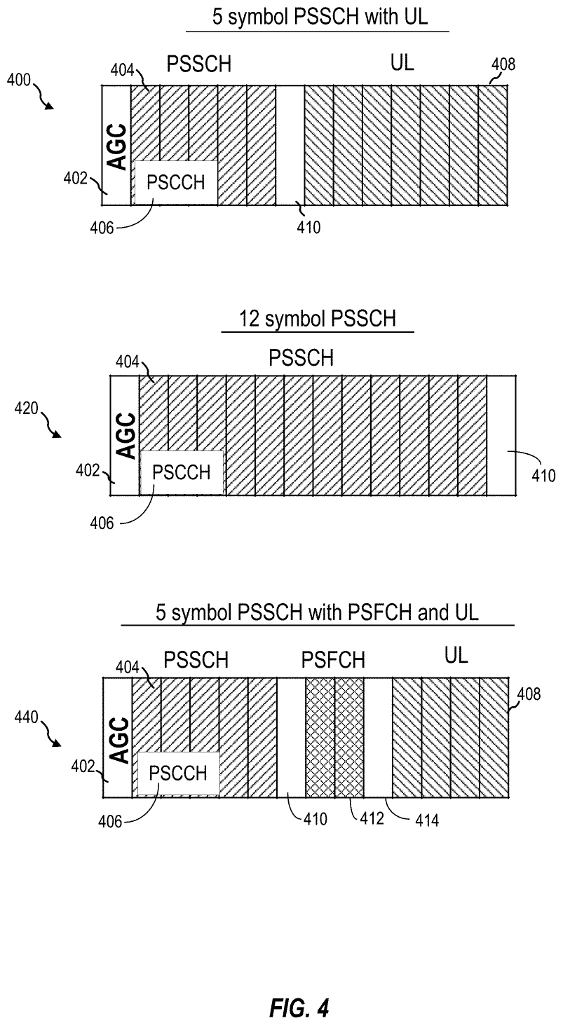

FIG. 4 depicts various example sidelink slot formats. The first example sidelink slot structure 400 comprises 14 OFDM symbols. The first symbol in slot structure 400 is a symbol designated for use for AGC by a receiver, and thus may be referred to as an “AGC symbol” 402. Slot structure 400 further includes five PSSCH symbols 404 corresponding to a sidelink data portion of the sidelink slot structure 400. Generally, the PSSCH can be 5 to 12 symbols long, based on the sidelink symbol length parameter. Slot structure 400 further includes PSCCH symbols 406, which in this example is 3 symbols long starting at the second sidelink symbol and corresponding to a control portion of the sidelink slot structure 400. Generally, the PSCCH symbols 406 are 2 or 3 symbols in length and are frequency duplexed with the PSSCH symbols. In the first example sidelink slot structure 400, the PSSCH symbols 404 are followed by a gap symbol 410. The gap symbol allows the user equipment to switch beams or switch from receiving to transmitting. The final OFDM symbols of sidelink slot structure 400 are dedicated to uplink symbols 408 (e.g., uplink to a network). In this example, sidelink slot structure 400, there are 6 total sidelink symbols, 1 gap symbol, and 7 uplink symbols.

The second example sidelink slot structure 420 also comprises 14 OFDM symbols. Similar to the first example sidelink slot structure 400, the first symbol 402 is used for AGC. The next 12 symbols are PSSCH symbols 404. Similar to the first example sidelink slot structure 400, sidelink structure 420 includes 3 PSCCH symbols 406 frequency duplexed with the PSSCH symbols starting at the second slot symbol. The PSSCH symbols 404 are followed by a gap symbol 410.

The third example sidelink slot structure 440 also comprises 14 OFDM symbols. Similar to the first example sidelink slot structure 400, the first symbol 402 is used for AGC. The next 5 symbols are PSSCH symbols 404, which include 3 frequency duplexed PSCCH symbols starting at the second sidelink symbol. The PSSCH symbols 404 are followed by gap symbol 410. Starting at the eighth symbol, there are two PSFCH symbols 412 followed by another gap symbol 414. Lastly, sidelink slot structure 440 includes uplink symbols 408.

Note that the example sidelink slot structures 400, 420, and 440 are just a few examples, and many other structures (or formats) are possible.

In some cases, when transmitting and/or receiving using conventional sidelink slot structures, not all fourteen OFDM symbols are used, which means the unallocated portions of the slot go unused in the communication system, leading to lower spectrum efficiency. In order to improve efficiency, and to enable new communication modes, aspects described herein relate to sidelink “mini-slots”, which are intra-slot communication structures. Mini-slots are beneficial for transmitting and receiving small amounts of data within a slot without requiring a conventional slot structure.

### Aspects Related to Enabling Mini-Slot in Sidelink Communications

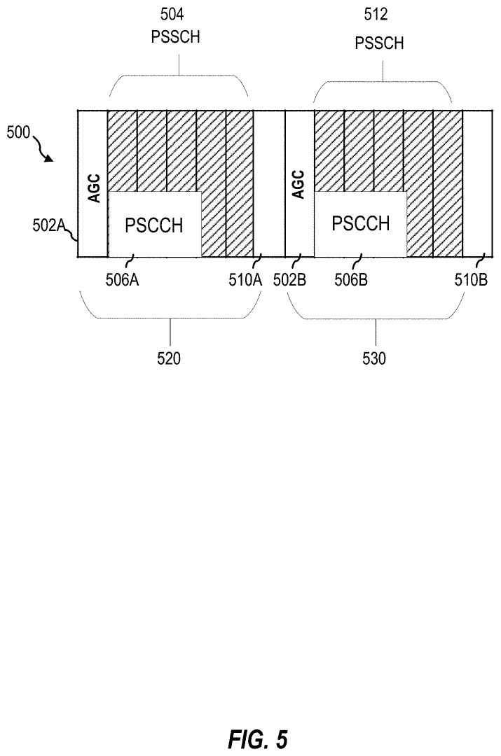

FIG. 5 depicts an example of sidelink mini-slot structures within a conventional sidelink slot structure 500, according to aspects of the present disclosure.

In the depicted example, sidelink slot structure 500 includes 2 mini-slots, 520 and 530. Similar to the other sidelink slot structures discussed above with reference to FIG. 4, each mini-slot (520 and 530) includes a symbol (502A and 502B) for use in AGC, which allows receiving user equipment to accurately set, for example, a gain that will maximize an analog-to-digital converter (ADC) range based on the received power of a communication signal (e.g., corresponding to a mini-slot), thereby improving signal-to-noise ratio (SNR).

In this sidelink slot structure 500, the first mini-slot 520 is 7 OFDM symbols in length. The first mini-slot 520 comprises five PSSCH symbols 504 and three PSCCH symbols 506A. The PSSCH symbols 504 are followed by a gap symbol 510A. The gap symbol 510A provides time for switching beams or communication direction, when necessary. The second mini-slot 530 is similarly 7 OFDM symbols in length and generally has the same arrangement as mini-slot 520, including PSSCH symbols 512, PSCCH symbols 506B, and gap symbol 510B.

Similar to conventional sidelink slot structures, here the entire sidelink slot structure 500 is 14 OFDM symbols in length. However, mini-slots 520 and 530 allow for sending and/or receiving compact data transmissions to multiple recipients and/or senders within a single slot structure. Conventionally, the entire sidelink slot is used to transmit to one recipient/receive from one sender, and a small data transmission in a full slot structure would have left the remaining slot underutilized, but with mini-slots, slot utilization may be increased, thus leading to greater utilization of the spectrum, while beneficially reducing communication latency.

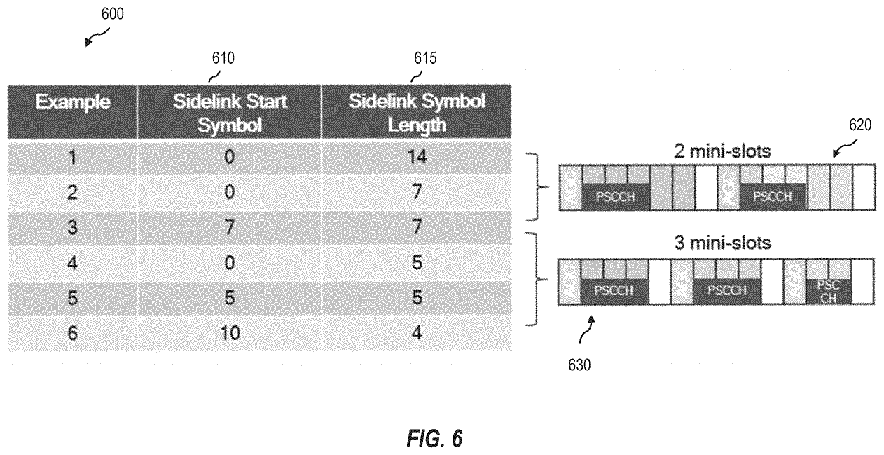

FIG. 6 depicts further examples of mini-slot structures, including related sidelink configuration parameters, according to aspects of the present disclosure.

Specifically, in this example, the sidelink configuration parameters include sidelink symbol start parameters 610 and sidelink symbol length parameters 615. The sidelink symbol start parameter 610 corresponds to a starting symbol for sidelink data in a sidelink slot structure and the sidelink symbol length parameter corresponds to a number of symbols in the sidelink data portion of the sidelink slot structure.

As depicted, different sidelink slot configurations (e.g., examples 1 through 6) can be used to enable different mini-slot configurations. For example, configuration example 1 can be used to support a SL slot, configuration examples 2 through 3 can be used to support two mini-slots within a slot, as shown at 620, and configuration examples 4 through 6 can be used to support three mini-slots within a slot, as shown at 630. Note that these are just a few examples, and others are possible.

In some cases, these various configurations can be configured for different resource pools. For example, a first resource pool may allow slot-based transmissions with two mini-slots (as in the example at 620), while a second resource pool configuration may allow slot-based transmissions with three mini-slots (as in the example at 630). Other configurations are possible.

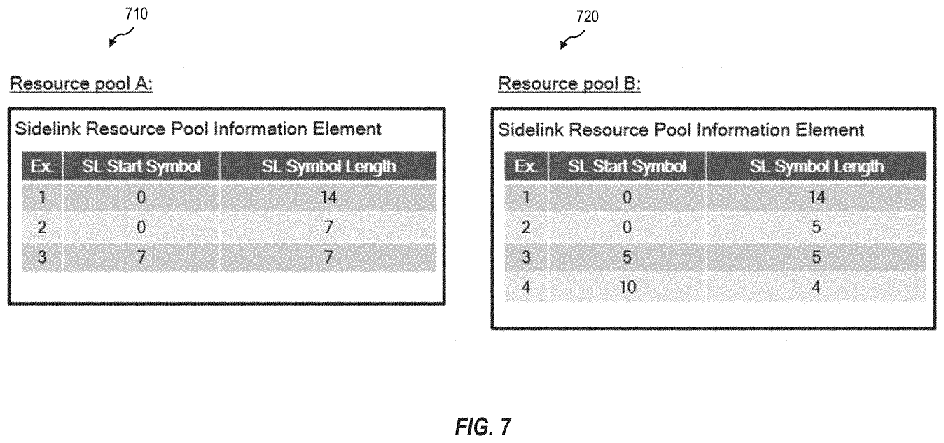

For example, FIG. 7 depicts sidelink resource pool information elements 710 and 720, each configured with sidelink configuration examples for different resource pools. When using an information elements such as 710 and 720, the sidelink start symbol and sidelink symbol length parameters can be removed from generic sidelink bandwidth part configurations, allowing for more granular control of mini-slot configurations among network entities, such as UEs. Note that these are just some examples, and others are possible.

### Example Methods for Enabling Mini-slot Detection in Sidelink

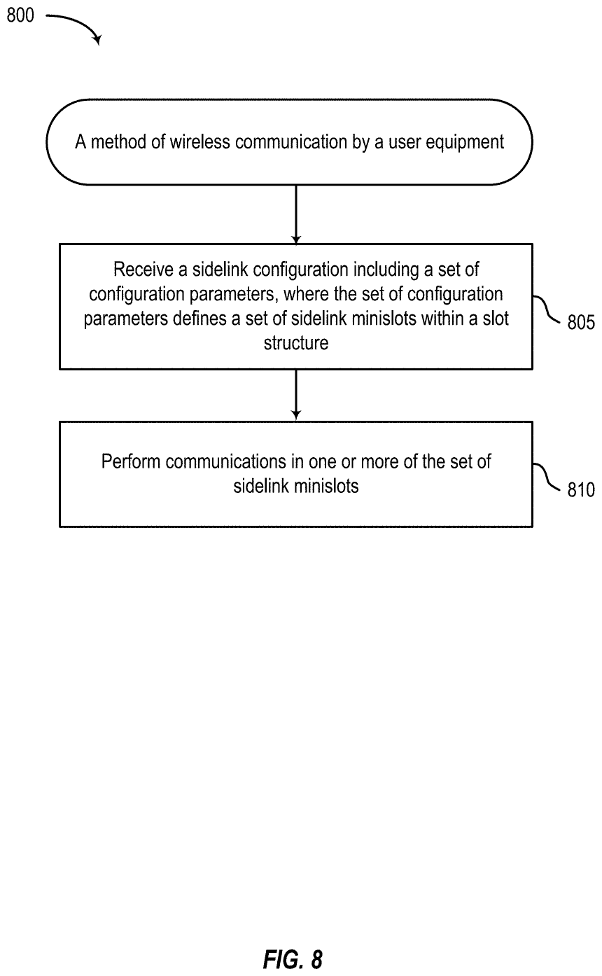

FIG. 8 shows an example of a method 800 for wireless communication according to aspects of the present disclosure. In some aspects, a user equipment, such as UE 104 of FIGS. 1 and 2, or processing system 905 of FIG. 9, may perform the method 800.

Operation 805 begins with receiving a sidelink configuration including a set of configuration parameters, where the set of configuration parameters defines a set of sidelink mini-slots within a slot structure. In some cases, the operations of this step refer to, or may be performed by, sidelink configuration circuitry 915 as described with reference to FIG. 9.

Operation 810 continues with performing communications in one or more of the set of sidelink mini-slots. In some cases, the operations of this step refer to, or may be performed by, sidelink communications circuitry 920 as described with reference to FIG. 9.

In some aspects, the sidelink configuration comprises a bandwidth part configuration comprising a first parameter and a second parameter, where the first parameter is configured to set a start symbol for each sidelink mini-slot of the plurality of sidelink mini-slots within the slot structure and the second parameter is configured to set a number of symbols for each sidelink mini-slot of the plurality of sidelink mini-slots within the slot structure. In some aspects, the first parameter comprises a sidelink symbol start parameter. For example, the sidelink symbol start parameter may comprise a sl-StartSymbol parameter. In some aspects, the second parameter comprises a sidelink symbol length parameter. For example, the sidelink symbol length parameter may comprise a sl-LengthSymbols parameter.

In some aspects, the sidelink configuration enables the user equipment to transmit and receive communications within any sidelink mini-slot of the plurality of sidelink mini-slots. In some aspects, the sidelink configuration configures the user equipment to transmit and receive communications using a subset of the plurality of sidelink mini-slots based on a resource pool associated with the user equipment.

In some aspects, the sidelink configuration comprises a resource pool configuration (e.g., as described with respect to FIG. 7), comprising a first parameter and a second parameter, where the first parameter is configured to set a start symbol for each sidelink mini-slot of the plurality of sidelink mini-slots within the slot structure and the second parameter is configured to set a number of symbols for each sidelink mini-slot of the plurality of sidelink mini-slots within the slot structure.

In some aspects, each sidelink mini-slot of the plurality of sidelink mini-slots is configured with a first symbol of the mini-slot comprising a repetition of a second symbol of the mini-slot.

In some aspects, the method 800 further includes communicating sidelink control information over a sidelink control channel simultaneously with sidelink data over a sidelink shared channel during at least one symbol of one sidelink mini-slot of the plurality of sidelink mini-slots.

In some aspects, the plurality of sidelink mini-slots comprises at least a first sidelink mini-slot with a first symbol length longer than a second sidelink mini-slot with a second symbol length shorter than the first symbol length.

In some aspects, a last PSSCH symbol of each respective sidelink mini-slot in the plurality of sidelink mini-slots is separated by at least one gap symbol from a first symbol of a sidelink mini-slot following the respective sidelink mini-slot.

Note that FIG. 8 is just one example of a method, and other methods including fewer, additional, or alternative steps are possible consistent with this disclosure.

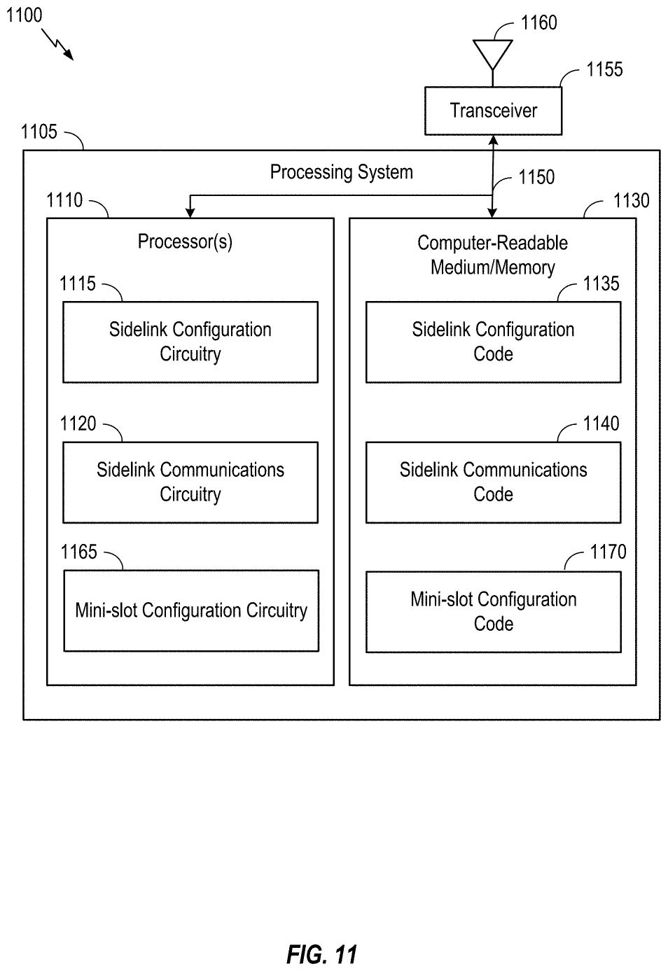

FIG. 9 shows an example of a method 900 for wireless communication according to aspects of the present disclosure. In some aspects, a base station, such as B S 102 of FIGS. 1 and 2, or processing system 1105 of FIG. 11, may perform the method 900.

Operation 905 begins with transmitting a sidelink configuration to a user equipment including a set of configuration parameters, wherein the set of configuration parameters defines a set of sidelink mini-slots within a slot structure. In some cases, the operations of this step refer to, or may be performed by, sidelink configuration circuitry 1115 as described with reference to FIG. 11.

In some aspects, the sidelink configuration comprises a bandwidth part configuration comprising a first parameter and a second parameter, where the first parameter is configured to set a start symbol for each sidelink mini-slot of the plurality of sidelink mini-slots within the slot structure and the second parameter is configured to set a number of symbols for each sidelink mini-slot of the plurality of sidelink mini-slots within the slot structure. In some aspects, the first parameter comprises a sidelink symbol start parameter. For example, the sidelink symbol start parameter may comprise a sl-StartSymbol parameter. In some aspects, the second parameter comprises a sidelink symbol length parameter. For example, the sidelink symbol length parameter may comprise a sl-LengthSymbols parameter.

In some aspects, the sidelink configuration enables the user equipment to transmit and receive communications within any sidelink mini-slot of the plurality of sidelink mini-slots. In some aspects, the sidelink configuration configures the user equipment to transmit and receive communications using a subset of the plurality of sidelink mini-slots based on a resource pool associated with the user equipment.

In some aspects, the sidelink configuration comprises a resource pool configuration (e.g., as described with respect to FIG. 7), comprising a first parameter and a second parameter, where the first parameter is configured to set a start symbol for each sidelink mini-slot of the plurality of sidelink mini-slots within the slot structure and the second parameter is configured to set a number of symbols for each sidelink mini-slot of the plurality of sidelink mini-slots within the slot structure.

In some aspects, each sidelink mini-slot of the plurality of sidelink mini-slots is configured with a first symbol comprising a repetition of a second symbol.

In some aspects, the plurality of sidelink mini-slots comprises at least a first sidelink mini-slot with a first symbol length longer than a second sidelink mini-slot with a second symbol length shorter than the first symbol length.

In some aspects, a last PSSCH symbol of each respective sidelink mini-slot in the plurality of sidelink mini-slots is separated by at least one gap symbol from a first symbol of a sidelink mini-slot following the respective sidelink mini-slot.

Note that FIG. 9 is just one example of a method, and other methods including fewer, additional, or alternative steps are possible consistent with this disclosure.

### Example Wireless Communication Devices

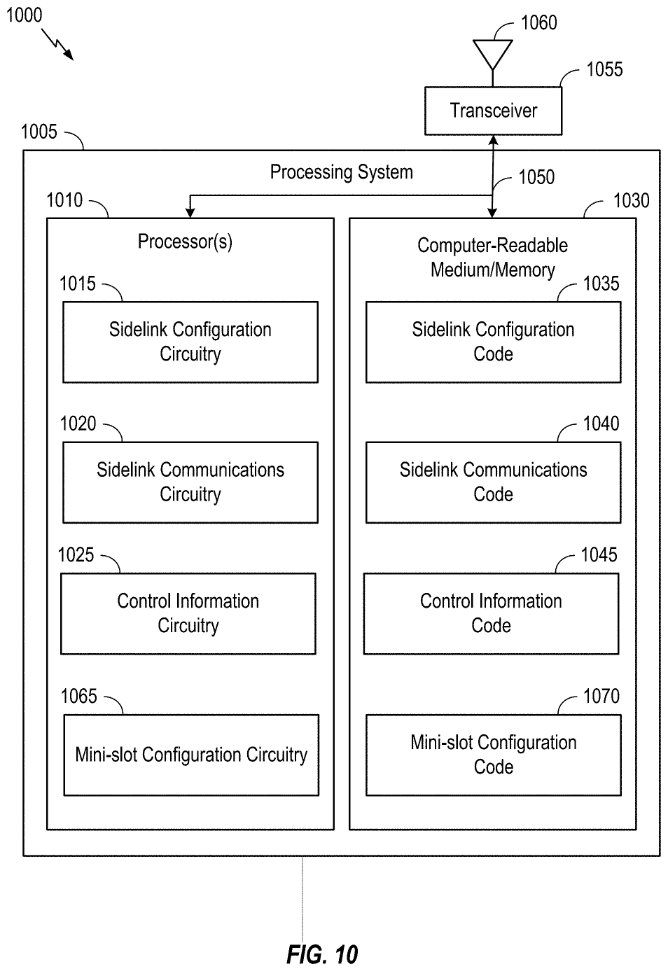

FIG. 10 depicts an example communications device 1000 that includes various components operable, configured, or adapted to perform operations for the techniques disclosed herein, such as the operations depicted and described with respect to FIGS. 5-8. In some examples, communication device may be a user equipment 104 as described, for example with respect to FIGS. 1 and 2.

Communications device 1000 includes a processing system 1005 coupled to the transceiver 1055 (e.g., a transmitter and/or a receiver). The transceiver 1055 is configured to transmit (or send) and receive signals for the communications device 1000 via the antenna 1060, such as the various signals as described herein. The transceiver 1055 may communicate bi-directionally, via the antennas 1060, wired links, or wireless links as described herein. For example, the transceiver 1055 may represent a wireless transceiver and may communicate bi-directionally with another wireless transceiver. The transceiver 1055 may also include or be connected to a modem to modulate the packets and provide the modulated packets to for transmission, and to demodulate received packets. In some examples, the transceiver 1055 may be tuned to operate at specified frequencies. For example, a modem can configure the transceiver 1055 to operate at a specified frequency and power level based on the communication protocol used by the modem.

Processing system 1005 may be configured to perform processing functions for communications device 1000, including processing signals received and/or to be transmitted by communications device 1000. Processing system 1005 includes one or more processors 1010 coupled to a computer-readable medium/memory 1030 via a bus 1050.

In some examples, one or more processors 1010 may include one or more intelligent hardware devices, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or any combination thereof). In some cases, the one or more processors 1010 are configured to operate a memory array using a memory controller. In other cases, a memory controller is integrated into the one or more processors 1010. In some cases, the one or more processors 1010 are configured to execute computer-readable instructions stored in a memory to perform various functions. In some aspects, one or more processors 1010 include special purpose components for modem processing, baseband processing, digital signal processing, or transmission processing.

In certain aspects, computer-readable medium/memory 1030 is configured to store instructions (e.g., computer-executable code) that when executed by the one or more processors 1010, cause the one or more processors 1010 to perform the operations illustrated in FIG. 8, or other operations for performing the various techniques discussed herein.

In one aspect, computer-readable medium/memory 1030 includes sidelink configuration code 1035, sidelink communications code 1040, control information code 1045, and mini-slot configuration code 1070.

Examples of a computer-readable medium/memory 1030 include random access memory (RAM), read-only memory (ROM), solid state memory, a hard drive, a hard disk drive, etc. In some examples, computer-readable medium/memory 1030 is used to store computer-readable, computer-executable software including instructions that, when executed, cause a processor to perform various functions described herein. In some cases, the memory contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within a memory store information in the form of a logical state.

Various components of communications device 1000 may provide means for performing the methods described herein, including with respect to FIG. 8.

In some examples, means for transmitting or sending (or means for outputting for transmission) may include transceivers 254 and/or antenna(s) 252 of the user equipment 104 illustrated in FIG. 2 and/or the transceiver 1055 and the antenna 1060 of the communications device 1000 in FIG. 10.

In some examples, means for receiving (or means for obtaining) may include transceivers 254 and/or antenna(s) 252 of the user equipment 104 illustrated in FIG. 2 and/or the transceiver 1055 and the antenna 1060 of the communications device 1000 in FIG. 10.

In some examples, means for receiving a sidelink configuration, means for performing communications, and means for communicating sidelink control information may include various processing system 1005 components, such as: the one or more processors 1010 in FIG. 10, or aspects of the user equipment 104 depicted in FIG. 2, including receive processor 258, transmit processor 264, TX MIMO processor 266, and/or controller/processor 280.

In one aspect, one or more processors 1010 includes sidelink configuration circuitry 1015, sidelink communications circuitry 1020, control information circuitry 1025, and mini-slot configuration circuitry 1065.

According to some aspects, sidelink configuration circuitry 1015 receives a sidelink configuration including a set of configuration parameters, where the set of configuration parameters defines a set of sidelink mini-slots within a slot structure. In some aspects, the sidelink configuration includes a bandwidth part configuration including a first parameter and a second parameter, where the first parameter is configured to set a start symbol for each sidelink mini-slot of the set of sidelink mini-slots within the slot structure and the second parameter is configured to set a number of symbols for each sidelink mini-slot of the set of sidelink mini-slots within the slot structure. In some aspects, the first parameter includes a sidelink symbol start parameter. For example, sl-StartSymbol parameter. In some aspects, the second parameter includes a sidelink symbol length parameter. For example, sl-LengthSymbols parameter.

In some aspects, the sidelink configuration enables the user equipment to transmit and receive communications within any sidelink mini-slot of the set of sidelink mini-slots. In some aspects, the sidelink configuration configures the user equipment to transmit and receive communications using a subset of the set of sidelink mini-slots based on a resource pool associated with the user equipment.

In some aspects, the sidelink configuration includes a resource pool configuration, including a first parameter and a second parameter, where the first parameter is configured to set a start symbol for each sidelink mini-slot of the set of sidelink mini-slots within the slot structure and the second parameter is configured to set a number of symbols for each sidelink mini-slot of the set of sidelink mini-slots within the slot structure. In some aspects, each sidelink mini-slot of the set of sidelink mini-slots is configured with a first symbol including a repetition of a second symbol. In some aspects, the set of sidelink mini-slots includes at least a first sidelink mini-slot with a first symbol length longer than a second sidelink mini-slot with a second symbol length shorter than the first symbol length. In some aspects, a last PSSCH symbol of each respective sidelink mini-slot in the set of sidelink mini-slots is separated by at least one gap symbol from a first symbol of a sidelink mini-slot following the respective sidelink mini-slot.

According to some aspects, sidelink communications circuitry 1020 performs communications in one or more of the set of sidelink mini-slots.

According to some aspects, control information circuitry 1025 communicates sidelink control information over a sidelink control channel simultaneously with sidelink data over a sidelink shared channel during at least one symbol of one sidelink mini-slot of the set of sidelink mini-slots.

According to some aspects, mini-slot configuration circuitry 1065 configures mini-slots for various network entities, including user equipments, such as user equipment 104 illustrated in FIG. 2.

Notably, FIG. 10 is just one example, and many other examples and configurations of communication device are possible.

FIG. 11 depicts an example communications device 1100 that includes various components operable, configured, or adapted to perform operations for the techniques disclosed herein, such as the operations depicted and described with respect to FIG. 9. In some examples, communication device 1100 may be a BS 102 as described, for example with respect to FIGS. 1 and 2.

Communications device 1100 includes a processing system 1105 coupled to the transceiver 1155 (e.g., a transmitter and/or a receiver). The transceiver 1155 is configured to transmit (or send) and receive signals for the communications device 1100 via the antenna 1160, such as the various signals as described herein. The transceiver 1155 may communicate bi-directionally, via the antennas 1160, wired links, or wireless links as described herein. For example, the transceiver 1155 may represent a wireless transceiver and may communicate bi-directionally with another wireless transceiver. The transceiver 1155 may also include or be connected to a modem to modulate the packets and provide the modulated packets to for transmission, and to demodulate received packets. In some examples, the transceiver 1155 may be tuned to operate at specified frequencies. For example, a modem can configure the transceiver 1155 to operate at a specified frequency and power level based on the communication protocol used by the modem.

Processing system 1105 may be configured to perform processing functions for communications device 1100, including processing signals received and/or to be transmitted by communications device 1000. Processing system 1105 includes one or more processors 1110 coupled to a computer-readable medium/memory 1130 via a bus 1150.

In some examples, one or more processors 1110 may include one or more intelligent hardware devices, (e.g., a general-purpose processing component, a DSP, a CPU, a GPU, a microcontroller, an ASIC, a FPGA, a programmable logic device, a discrete gate or transistor logic component, a discrete hardware component, or any combination thereof). In some cases, the one or more processors 1110 are configured to operate a memory array using a memory controller. In other cases, a memory controller is integrated into the one or more processors 1110. In some cases, the one or more processors 1110 are configured to execute computer-readable instructions stored in a memory to perform various functions. In some aspects, one or more processors 1110 include special purpose components for modem processing, baseband processing, digital signal processing, or transmission processing.

In certain aspects, computer-readable medium/memory 1130 is configured to store instructions (e.g., computer-executable code) that when executed by the one or more processors 1110, cause the one or more processors 1110 to perform the operations illustrated in FIG. 9, or other operations for performing the various techniques discussed herein.

In one aspect, computer-readable medium/memory 1130 includes sidelink configuration code 1135, sidelink communications code 1140, and mini-slot configuration code 1170.

Examples of a computer-readable medium/memory 1130 include RAM, ROM, solid state memory, a hard drive, a hard disk drive, etc. In some examples, computer-readable medium/memory 1130 is used to store computer-readable, computer-executable software including instructions that, when executed, cause a processor to perform various functions described herein. In some cases, the memory contains, among other things, a BIOS which controls basic hardware or software operation such as the interaction with peripheral components or devices. In some cases, a memory controller operates memory cells. For example, the memory controller can include a row decoder, column decoder, or both. In some cases, memory cells within a memory store information in the form of a logical state.

Various components of communications device 1100 may provide means for performing the methods described herein, including with respect to FIG. 9.

In some examples, means for transmitting or sending (or means for outputting for transmission) may include transceivers 232 and/or antenna(s) 234 of the BS 102 illustrated in FIG. 2 and/or the transceiver 1155 and the antenna 1160 of the communication device in FIG. 11.

In some examples, means for receiving (or means for obtaining) may include transceivers 232 and/or antenna(s) 234 of the BS 102 illustrated in FIG. 2 and/or the transceiver 1155 and the antenna 1160 of the communication device in FIG. 11.

In one aspect, one or more processors 1110 includes sidelink configuration circuitry 1115, sidelink communications circuitry 1120, and mini-slot configuration circuitry 1165.

In some examples, means for transmitting may include various processing system 1105 components, such as: the one or more processors 1110 in FIG. 11, or aspects of the BS 102 depicted in FIG. 2, including receive processor 238, transmit processor 220, TX MIMO processor 230, and/or controller/processor 240 (including mini-slot configuration component 241).

According to one aspect, sidelink configuration circuitry 1115 transmits a sidelink configuration including a set of configuration parameters, where the set of configuration parameters defines a set of sidelink mini-slots within a slot structure. In some aspects, the sidelink configuration includes a bandwidth part configuration including a first parameter and a second parameter, where the first parameter is configured to set a start symbol for each sidelink mini-slot of the set of sidelink mini-slots within the slot structure and the second parameter is configured to set a number of symbols for each sidelink mini-slot of the set of sidelink mini-slots within the slot structure. In some aspects, the first parameter includes a sidelink symbol start parameter, such as a sl-StartSymbol parameter. In some aspects, the second parameter includes a sidelink symbol length parameter, such as a sl-LengthSymbols parameter.

According to some aspects, mini-slot configuration circuitry 1165 configures mini-slots for various network entities, including user equipments, such as user equipment 104 illustrated in FIG. 2.

Notably, FIG. 11 is just one example, and many other examples and configurations of communication device are possible.

### Example Clauses

Implementation examples are described in the following numbered clauses:

Clause 1: A method for wireless communications by a user equipment, the method comprising: receiving a sidelink configuration comprising a set of configuration parameters, wherein the set of configuration parameters defines a plurality of sidelink mini-slots within a slot structure; and performing communications in one or more of the plurality of sidelink mini-slots.

Clause 2: The method of Clause 1, wherein the sidelink configuration comprises a bandwidth part configuration comprising: a first parameter configured to set a start symbol for each sidelink mini-slot of the plurality of sidelink mini-slots within the slot structure; and a second parameter configured to set a number of symbols for each sidelink mini-slot of the plurality of sidelink mini-slots within the slot structure.

Clause 3: The method of Clause 2, wherein the first parameter comprises a sidelink symbol start parameter.

Clause 4: The method of any one of Clauses 2-3, wherein the second parameter comprises a sidelink symbol length parameter.

Clause 5: The method of any one of Clauses 2-4, wherein the sidelink configuration enables the user equipment to transmit and receive communications within any sidelink mini-slot of the plurality of sidelink mini-slots.

Clause 6: The method of any one of Clauses 2-5, wherein the sidelink configuration configures the user equipment to transmit and receive communications using a subset of the plurality of sidelink mini-slots based on a resource pool associated with the user equipment.

Clause 7: The method of any one of Clauses 1-6, wherein the sidelink configuration comprises a resource pool configuration, comprising: a first parameter configured to set a start symbol for each sidelink mini-slot of the plurality of sidelink mini-slots within the slot structure; and a second parameter configured to set a number of symbols for each sidelink mini-slot of the plurality of sidelink mini-slots within the slot structure.

Clause 8: The method of any one of Clauses 1-7, wherein each sidelink mini-slot of the plurality of sidelink mini-slots is configured with a first symbol comprising a repetition of a second symbol.

Clause 9: The method of any one of Clauses 1-8, further comprising: communicating sidelink control information over a sidelink control channel simultaneously with sidelink data over a sidelink shared channel during at least one symbol of one sidelink mini-slot of the plurality of sidelink mini-slots.

Clause 10: The method of any one of Clauses 1-9, wherein the plurality of sidelink mini-slots comprises at least a first sidelink mini-slot with a first symbol length longer than a second sidelink mini-slot with a second symbol length shorter than the first symbol length.

Clause 11: The method of any one of Clauses 1-10, wherein a last PSSCH symbol of each respective sidelink mini-slot in the plurality of sidelink mini-slots is separated by at least one gap symbol from a first symbol of a sidelink mini-slot following the respective sidelink mini-slot.

Clause 12: A method for wireless communications by a base station, the method comprising: transmitting a sidelink configuration comprising a set of configuration parameters to a user equipment, wherein the set of configuration parameters defines a plurality of sidelink mini-slots within a slot structure.

Clause 13: The method of Clause 12, wherein the sidelink configuration comprises a bandwidth part configuration comprising: a first parameter configured to set a start symbol for each sidelink mini-slot of the plurality of sidelink mini-slots within the slot structure; and a second parameter configured to set a number of symbols for each sidelink mini-slot of the plurality of sidelink mini-slots within the slot structure.

Clause 14: The method of Clause 13, wherein the first parameter comprises a sidelink symbol start parameter.

Clause 15: The method of any one of Clauses 13-14, wherein the second parameter comprises a sidelink symbol length parameter.

Clause 16: The method of any one of Clauses 13-15, wherein the sidelink configuration enables the user equipment to transmit and receive communications within any sidelink mini-slot of the plurality of sidelink mini-slots.

Clause 17: The method of any one of Clauses 13-16, wherein the sidelink configuration configures the user equipment to transmit and receive communications using a subset of the plurality of sidelink mini-slots based on a resource pool associated with the user equipment.

Clause 18: The method of any one of Clauses 12-17, wherein the sidelink configuration comprises a resource pool configuration, comprising: a first parameter configured to set a start symbol for each sidelink mini-slot of the plurality of sidelink mini-slots within the slot structure; and a second parameter configured to set a number of symbols for each sidelink mini-slot of the plurality of sidelink mini-slots within the slot structure.

Clause 19: The method of any one of Clauses 12-18, wherein each sidelink mini-slot of the plurality of sidelink mini-slots is configured with a first symbol comprising a repetition of a second symbol.

Clause 20: The method of any one of Clauses 12-19, wherein the plurality of sidelink mini-slots comprises at least a first sidelink mini-slot with a first symbol length longer than a second sidelink mini-slot with a second symbol length shorter than the first symbol length.

Clause 21: The method of any one of Clauses 12-20, wherein a last PSSCH symbol of each respective sidelink mini-slot in the plurality of sidelink mini-slots is separated by at least one gap symbol from a first symbol of a sidelink mini-slot following the respective sidelink mini-slot.

Clause 22: A processing system, comprising: a memory comprising computer-executable instructions; one or more processors configured to execute the computer-executable instructions and cause the processing system to perform a method in accordance with any one of Clauses 1-21.

Clause 23: A processing system, comprising means for performing a method in accordance with any one of Clauses 1-21.

Clause 24: A non-transitory computer-readable medium comprising computer-executable instructions that, when executed by one or more processors of a processing system, cause the processing system to perform a method in accordance with any one of Clauses 1-21.

Clause 25: A computer program product embodied on a computer-readable storage medium comprising code for performing a method in accordance with any one of Clauses 1-21.

### Additional Wireless Communication Network Considerations

The techniques and methods described herein may be used for various wireless communications networks (or wireless wide area network (WWAN)) and radio access technologies (RATs). While aspects may be described herein using terminology commonly associated with 3G, 4G, and/or 5G (e.g., 5G new radio (NR)) wireless technologies, aspects of the present disclosure may likewise be applicable to other communication systems and standards not explicitly mentioned herein.

5G wireless communication networks may support various advanced wireless communication services, such as enhanced mobile broadband (eMBB), millimeter wave (mmWave), machine type communications (MTC), and/or mission critical targeting ultra-reliable, low-latency communications (URLLC). These services, and others, may include latency and reliability requirements.

Returning to FIG. 1, various aspects of the present disclosure may be performed within the example wireless communication network 100.

In 3GPP, the term “cell” can refer to a coverage area of a NodeB and/or a narrowband subsystem serving this coverage area, depending on the context in which the term is used. In NR systems, the term “cell” and BS, next generation NodeB (gNB or gNodeB), access point (AP), distributed unit (DU), carrier, or transmission reception point may be used interchangeably. A BS may provide communication coverage for a macro cell, a pico cell, a femto cell, and/or other types of cells.

A macro cell may generally cover a relatively large geographic area (e.g., several kilometers in radius) and may allow unrestricted access by UEs with service subscription. A pico cell may cover a relatively small geographic area (e.g., a sports stadium) and may allow unrestricted access by UEs with service subscription. A femto cell may cover a relatively small geographic area (e.g., a home) and may allow restricted access by UEs having an association with the femto cell (e.g., UEs in a Closed Subscriber Group (CSG) and UEs for users in the home). A BS for a macro cell may be referred to as a macro BS. A BS for a pico cell may be referred to as a pico BS. A BS for a femto cell may be referred to as a femto BS, home BS, or a home NodeB.

Base stations 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). Base stations 102 configured for 5G (e.g., 5G NR or Next Generation RAN (NG-RAN)) may interface with 5GC 190 through second backhaul links 184. Base stations 102 may communicate directly or indirectly (e.g., through the EPC 160 or 5GC 190) with each other over third backhaul links 134 (e.g., X2 interface). Third backhaul links 134 may generally be wired or wireless.

Small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. Small cell 102′, employing NR in an unlicensed frequency spectrum, may boost coverage to and/or increase capacity of the access network.

Some base stations, such as gNB 180 may operate in a traditional sub-6 GHz spectrum, in millimeter wave (mmWave) frequencies, and/or near mmWave frequencies in communication with the UE 104. When the gNB 180 operates in mmWave or near mmWave frequencies, the gNB 180 may be referred to as an mmWave base station.

The communication links 120 between base stations 102 and, for example, UEs 104, may be through one or more carriers. For example, base stations 102 and UEs 104 may use spectrum up to Y MHz (e.g., 5, 10, 15, 20, 100, 400, and other MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Wireless communications system 100 further includes a Wi-Fi access point (AP) 150 in communication with Wi-Fi stations (STAs) 152 via communication links 154 in, for example, a 2.4 GHz and/or 5 GHz unlicensed frequency spectrum. When communicating in an unlicensed frequency spectrum, the STAs 152/AP 150 may perform a clear channel assessment (CCA) prior to communicating in order to determine whether the channel is available.

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a PSSCH, and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, 4G (e.g., LTE), or 5G (e.g., NR), to name a few options.

EPC 160 may include a Mobility Management Entity (MME) 162, other MMES 164, a Serving Gateway 166, a Multimedia Broadcast Multicast Service (MBMS) Gateway 168, a Broadcast Multicast Service Center (BM-SC) 170, and a Packet Data Network (PDN) Gateway 172. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to the IP Services 176, which may include, for example, the Internet, an intranet, an IP Multimedia Subsystem (IMS), a PS Streaming Service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and may be used to schedule MBMS transmissions. MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

5GC 190 may include an Access and Mobility Management Function (AMF) 192, other AMFs 193, a Session Management Function (SMF) 194, and a User Plane Function (UPF) 195. AMF 192 may be in communication with a Unified Data Management (UDM) 196.

AMF 192 is generally the control node that processes the signaling between UEs 104 and 5GC 190. Generally, AMF 192 provides QoS flow and session management.

All user Internet protocol (IP) packets are transferred through UPF 195, which is connected to the IP Services 197, and which provides UE IP address allocation as well as other functions for 5GC 190. IP Services 197 may include, for example, the Internet, an intranet, an IP Multimedia Subsystem (IMS), a PS Streaming Service, and/or other IP services.

Returning to FIG. 2, various example components of BS 102 and UE 104 (e.g., the wireless communication network 100 of FIG. 1) are depicted, which may be used to implement aspects of the present disclosure.

At BS 102, a transmit processor 220 may receive data from a data source 212 and control information from a controller/processor 240. The control information may be for the physical broadcast channel (PBCH), physical control format indicator channel (PCFICH), physical hybrid ARQ indicator channel (PHICH), physical downlink control channel (PDCCH), group common PDCCH (GC PDCCH), and others. The data may be for the physical downlink shared channel (PDSCH), in some examples.

A medium access control (MAC)-control element (MAC-CE) is a MAC layer communication structure that may be used for control command exchange between wireless nodes. The MAC-CE may be carried in a shared channel such as a physical downlink shared channel (PDSCH), a physical uplink shared channel (PUSCH), or a PSSCH.

Processor 220 may process (e.g., encode and symbol map) the data and control information to obtain data symbols and control symbols, respectively. Transmit processor 220 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 230 may perform spatial processing (e.g., precoding) on the data symbols, the control symbols, and/or the reference symbols, if applicable, and may provide output symbol streams to the modulators (MODs) in transceivers 232a-232t. Each modulator in transceivers 232a-232t may process a respective output symbol stream (e.g., for OFDM) to obtain an output sample stream. Each modulator may further process (e.g., convert to analog, amplify, filter, and upconvert) the output sample stream to obtain a downlink signal. Downlink signals from the modulators in transceivers 232a-232t may be transmitted via the antennas 234a-234t, respectively.

At UE 104, antennas 252a-252r may receive the downlink signals from the BS 102 and may provide received signals to the demodulators (DEMODs) in transceivers 254a-254r, respectively. Each demodulator in transceivers 254a-254r may condition (e.g., filter, amplify, downconvert, and digitize) a respective received signal to obtain input samples. Each demodulator may further process the input samples (e.g., for OFDM) to obtain received symbols.

MIMO detector 256 may obtain received symbols from all the demodulators in transceivers 254a-254r, perform MIMO detection on the received symbols if applicable, and provide detected symbols. Receive processor 258 may process (e.g., demodulate, deinterleave, and decode) the detected symbols, provide decoded data for the UE 104 to a data sink 260, and provide decoded control information to a controller/processor 280.

On the uplink, at UE 104, transmit processor 264 may receive and process data (e.g., for the physical uplink shared channel (PUSCH)) from a data source 262 and control information (e.g., for the physical uplink control channel (PUCCH) from the controller/processor 280. Transmit processor 264 may also generate reference symbols for a reference signal (e.g., for the sounding reference signal (SRS)). The symbols from the transmit processor 264 may be precoded by a TX MIMO processor 266 if applicable, further processed by the modulators in transceivers 254a-254r (e.g., for SC-FDM), and transmitted to BS 102.

At BS 102, the uplink signals from UE 104 may be received by antennas 234a-t, processed by the demodulators in transceivers 232a-232t, detected by a MIMO detector 236 if applicable, and further processed by a receive processor 238 to obtain decoded data and control information sent by UE 104. Receive processor 238 may provide the decoded data to a data sink 239 and the decoded control information to the controller/processor 240.

Memories 242 and 282 may store data and program codes for BS 102 and UE 104, respectively.

Scheduler 244 may schedule UEs for data transmission on the downlink and/or uplink.

5G may utilize orthogonal frequency division multiplexing (OFDM) with a cyclic prefix (CP) on the uplink and downlink. 5G may also support half-duplex operation using time division duplexing (TDD). OFDM and single-carrier frequency division multiplexing (SC-FDM) partition the system bandwidth into multiple orthogonal subcarriers, which are also commonly referred to as tones and bins. Each subcarrier may be modulated with data. Modulation symbols may be sent in the frequency domain with OFDM and in the time domain with SC-FDM. The spacing between adjacent subcarriers may be fixed, and the total number of subcarriers may be dependent on the system bandwidth. The minimum resource allocation, called a resource block (RB), may be 12 consecutive subcarriers in some examples. The system bandwidth may also be partitioned into subbands. For example, a subband may cover multiple RBs. NR may support a base subcarrier spacing (SCS) of 15 KHz and other SCS may be defined with respect to the base SCS (e.g., 30 kHz, 60 kHz, 120 kHz, 240 kHz, and others).

As above, FIGS. 3A-3D depict various example aspects of data structures for a wireless communication network, such as wireless communication network 100 of FIG. 1.

In various aspects, the 5G frame structure may be frequency division duplex (FDD), in which for a particular set of subcarriers (carrier system bandwidth), subframes within the set of subcarriers are dedicated for either DL or UL. 5G frame structures may also be time division duplex (TDD), in which for a particular set of subcarriers (carrier system bandwidth), subframes within the set of subcarriers are dedicated for both DL and UL. In the examples provided by FIGS. 3A and 3C, the 5G frame structure is assumed to be TDD, with subframe 4 being configured with slot format 28 (with mostly DL), where D is DL, U is UL, and X is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description below applies also to a 5G frame structure that is TDD.

Other wireless communication technologies may have a different frame structure and/or different channels. A frame (10 ms) may be divided into 10 equally sized subframes (1 ms). Each subframe may include one or more time slots. Subframes may also include mini-slots, which may include 7, 4, or 2 symbols. In some examples, each slot may include 7 or 14 symbols, depending on the slot configuration.

For example, for slot configuration 0, each slot may include 14 symbols, and for slot configuration 1, each slot may include 7 symbols. The symbols on DL may be cyclic prefix (CP) OFDM (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission).

The number of slots within a subframe is based on the slot configuration and the numerology. For slot configuration 0, different numerologies (μ) 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2μ slots/subframe. The subcarrier spacing and symbol length/duration are a function of the numerology. The subcarrier spacing may be equal to 2^{μ}×15 kHz, where μ is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 3A-3D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 3A, some of the REs carry reference (pilot) signals (RS) for a UE (e.g., UE 104 of FIGS. 1 and 2). The RS may include demodulation RS (DM-RS) (indicated as Rx for one particular configuration, where 100× is the port number, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 3B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol.

A primary synchronization signal (PSS) may be within symbol 2 of particular subframes of a frame. The PSS is used by a UE (e.g., 104 of FIGS. 1 and 2) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 3C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 3D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Additional Considerations

The preceding description provides examples of enabling mini-slot detection in sidelink in communication systems. The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The techniques described herein may be used for various wireless communication technologies, such as 5G (e.g., 5G NR), 3GPP Long Term Evolution (LTE), LTE-Advanced (LTE-A), code division multiple access (CDMA), time division multiple access (TDMA), frequency division multiple access (FDMA), orthogonal frequency division multiple access (OFDMA), single-carrier frequency division multiple access (SC-FDMA), time division synchronous code division multiple access (TD-SCDMA), and other networks. The terms “network” and “system” are often used interchangeably. A CDMA network may implement a radio technology such as Universal Terrestrial Radio Access (UTRA), cdma2000, and others. UTRA includes Wideband CDMA (WCDMA) and other variants of CDMA. cdma2000 covers IS-2000, IS-95 and IS-856 standards. A TDMA network may implement a radio technology such as Global System for Mobile Communications (GSM). An OFDMA network may implement a radio technology such as NR (e.g. 5G RA), Evolved UTRA (E-UTRA), Ultra Mobile Broadband (UMB), IEEE 802.11 (Wi-Fi), IEEE 802.16 (WiMAX), IEEE 802.20, Flash-OFDMA, and others. UTRA and E-UTRA are part of Universal Mobile Telecommunication System (UMTS). LTE and LTE-A are releases of UMTS that use E-UTRA. UTRA, E-UTRA, UMTS, LTE, LTE-A and GSM are described in documents from an organization named “3rd Generation Partnership Project” (3GPP). cdma2000 and UMB are described in documents from an organization named “3rd Generation Partnership Project 2” (3GPP2). NR is an emerging wireless communications technology under development.

The various illustrative logical blocks, modules and circuits described in connection with the present disclosure may be implemented or performed with a general purpose processor, a DSP, an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of a user equipment (see FIG. 1), a user interface (e.g., keypad, display, mouse, joystick, touchscreen, biometric sensor, proximity sensor, light emitting element, and others) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer readable medium. Software shall be construed broadly to mean instructions, data, or any combination thereof, whether referred to as software, firmware, middleware, microcode, hardware description language, or otherwise. Computer-readable media include both computer storage media and communication media including any medium that facilitates transfer of a computer program from one place to another. The processor may be responsible for managing the bus and general processing, including the execution of software modules stored on the machine-readable storage media. A computer-readable storage medium may be coupled to a processor such that the processor can read information from, and write information to, the storage medium. In the alternative, the storage medium may be integral to the processor. By way of example, the machine-readable media may include a transmission line, a carrier wave modulated by data, and/or a computer readable storage medium with instructions stored thereon separate from the wireless node, all of which may be accessed by the processor through the bus interface. Alternatively, or in addition, the machine-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method for wireless communication by a user equipment, the method comprising:
receiving a sidelink configuration comprising a set of configuration parameters, wherein the set of configuration parameters defines a plurality of sidelink mini-slots within a slot structure; and
performing communications in one or more of the plurality of sidelink mini-slots.

2. The method of claim 1, wherein the sidelink configuration comprises a bandwidth part configuration comprising:
a first parameter configured to set a start symbol for each sidelink mini-slot of the plurality of sidelink mini-slots within the slot structure; and
a second parameter configured to set a number of symbols for each sidelink mini-slot of the plurality of sidelink mini-slots within the slot structure.

3. The method of claim 2, wherein the first parameter comprises a sidelink symbol start parameter.

4. The method of claim 2, wherein the second parameter comprises a sidelink symbol length parameter.

5. The method of claim 2, wherein the sidelink configuration enables the user equipment to transmit and receive communications within any sidelink mini-slot of the plurality of sidelink mini-slots.

6. The method of claim 2, wherein the sidelink configuration configures the user equipment to transmit and receive communications using a subset of the plurality of sidelink mini-slots based on a resource pool associated with the user equipment.

7. The method of claim 1, wherein the sidelink configuration comprises a resource pool configuration, comprising:
a first parameter configured to set a start symbol for each sidelink mini-slot of the plurality of sidelink mini-slots within the slot structure; and
a second parameter configured to set a number of symbols for each sidelink mini-slot of the plurality of sidelink mini-slots within the slot structure.

8. The method of claim 1, wherein each sidelink mini-slot of the plurality of sidelink mini-slots is configured with a first symbol comprising a repetition of a second symbol.

9. The method of claim 1, further comprising communicating sidelink control information over a sidelink control channel simultaneously with sidelink data over a sidelink shared channel during at least one symbol of one sidelink mini-slot of the plurality of sidelink mini-slots.

10. The method of claim 1, wherein the plurality of sidelink mini-slots comprises at least a first sidelink mini-slot with a first symbol length longer than a second sidelink mini-slot with a second symbol length shorter than the first symbol length.

11. The method of claim 1, wherein a last PSSCH symbol of each respective sidelink mini-slot in the plurality of sidelink mini-slots is separated by at least one gap symbol from a first symbol of a sidelink mini-slot following the respective sidelink mini-slot.

12. A user equipment configured for wireless communication, comprising: a memory comprising computer-executable instructions; and one or more processors configured to execute the computer-executable instructions and cause the user equipment to:
receive a sidelink configuration comprising a set of configuration parameters, wherein the set of configuration parameters defines a plurality of sidelink mini-slots within a slot structure; and
perform communications in one or more of the plurality of sidelink mini-slots.

13. The user equipment of claim 12, wherein the sidelink configuration comprises a bandwidth part configuration comprising:
a first parameter configured to set a start symbol for each sidelink mini-slot of the plurality of sidelink mini-slots within the slot structure; and
a second parameter configured to set a number of symbols for each sidelink mini-slot of the plurality of sidelink mini-slots within the slot structure.

14. The user equipment of claim 13, wherein the first parameter comprises a sidelink symbol start parameter.

15. The user equipment of claim 13, wherein the second parameter comprises a sidelink symbol length parameter.

16. The user equipment of claim 13, wherein the sidelink configuration enables the user equipment to transmit and receive communications within any sidelink mini-slot of the plurality of sidelink mini-slots.

17. The user equipment of claim 13, wherein the sidelink configuration configures the user equipment to transmit and receive communications using a subset of the plurality of sidelink mini-slots based on a resource pool associated with the user equipment.

18. The user equipment of claim 12, wherein the sidelink configuration comprises a resource pool configuration, comprising:
a first parameter configured to set a start symbol for each sidelink mini-slot of the plurality of sidelink mini-slots within the slot structure; and
a second parameter configured to set a number of symbols for each sidelink mini-slot of the plurality of sidelink mini-slots within the slot structure.

19. The user equipment of claim 12, wherein each sidelink mini-slot of the plurality of sidelink mini-slots is configured with a first symbol comprising a repetition of a second symbol.

20. The user equipment of claim 12, wherein the one or more processors are configured to execute the computer-executable instructions and further cause the user equipment to communicate sidelink control information over a sidelink control channel simultaneously with sidelink data over a sidelink shared channel during at least one symbol of one sidelink mini-slot of the plurality of sidelink mini-slots.

21. The user equipment of claim 12, wherein the plurality of sidelink mini-slots comprises at least a first sidelink mini-slot with a first symbol length longer than a second sidelink mini-slot with a second symbol length shorter than the first symbol length.

22. The user equipment of claim 12, wherein a last PSSCH symbol of each respective sidelink mini-slot in the plurality of sidelink mini-slots is separated by at least one gap symbol from a first symbol of a sidelink mini-slot following the respective sidelink mini-slot.

23. A non-transitory computer-readable medium comprising computer-executable instructions that, when executed by one or more processors of a user equipment, cause the user equipment to perform a method of wireless communication, comprising:
receiving a sidelink configuration comprising a set of configuration parameters, wherein the set of configuration parameters defines a plurality of sidelink mini-slots within a slot structure; and
performing communications in one or more of the plurality of sidelink mini-slots.

24. The non-transitory computer-readable medium of claim 23, wherein the sidelink configuration comprises a bandwidth part configuration comprising:
a first parameter configured to set a start symbol for each sidelink mini-slot of the plurality of sidelink mini-slots within the slot structure; and
a second parameter configured to set a number of symbols for each sidelink mini-slot of the plurality of sidelink mini-slots within the slot structure.

25. The non-transitory computer-readable medium of claim 24, wherein the first parameter comprises a sl-StartSymbol parameter.

26. The non-transitory computer-readable medium of claim 24, wherein the second parameter comprises a sl-LengthSymbols parameter.

27. The non-transitory computer-readable medium of claim 24, wherein the sidelink configuration enables the user equipment to transmit and receive communications within any sidelink mini-slot of the plurality of sidelink mini-slots.

28. The non-transitory computer-readable medium of claim 24, wherein the sidelink configuration configures the user equipment to transmit and receive communications using a subset of the plurality of sidelink mini-slots based on a resource pool associated with the user equipment.

29. The non-transitory computer-readable medium of claim 23, wherein the sidelink configuration comprises a resource pool configuration, comprising:
a first parameter configured to set a start symbol for each sidelink mini-slot of the plurality of sidelink mini-slots within the slot structure; and
a second parameter configured to set a number of symbols for each sidelink mini-slot of the plurality of sidelink mini-slots within the slot structure.

30. The non-transitory computer-readable medium of claim 23, wherein each sidelink mini-slot of the plurality of sidelink mini-slots is configured with a first symbol comprising a repetition of a second symbol.
